(19) United States
(12) Patent Application Publication
(10) Pub. No.: US 2010/0276236 A1
(43) Pub. Date: Nov. 4, 2010

(54) DAMPED PRODUCT AND METHOD OF MAKING THE SAME

(75) Inventors: Chongmin Kim, Bloomfield TWP, MI (US); Michael D. Hanna, West Boomfield, MI (US); James G. Schroth, Troy, MI (US)

Correspondence Address: General Motors Corporation;c/o REISING ETHINGTON P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/434,057

(22) Filed: May 1, 2009

(51) Int. Cl. F16D 65/12; B22F 3/02; B22F 3/12; B32B 5/00

(52) U.S. Cl. 188/218 XL; 419/66; 419/38; 428/547

(57) ABSTRACT

One exemplary embodiment includes a damped product. The damped product is composed of a sintered powder metallurgy material and has a first portion and a second portion. The first portion has a density that is greater in value that a density of the second portion. The different densities damp vibrations in the product when the product is vibrated.

### TECHNICAL FIELD

The technical field generally relates to damped products such as brake rotors, and methods of making the same.

### BACKGROUND

Powder metallurgy is a process of forming components and may include, among other steps, putting powdered material into a mold to produce a preform, and then applying pressure, relatively high temperature, relatively long sintering durations, or a combination thereof to produce a somewhat final form.

Products such as brake rotors may be commonly formed by a casting and machining process to have a generally homogeneous structure with a full density, resulting in a relatively heavy weight at a relatively high cost. Brake rotors may be subjected to vibrations and other sound-generating events during use that could have adverse effects such as noise generation with an increasing intensity over a prolonged period.

### SUMMARY OF EXEMPLARY EMBODIMENTS OF THE INVENTION

One exemplary embodiment includes a product which may include a brake rotor including a cheek portion. The cheek portion may have at least one working portion being acted upon directly or indirectly by a braking element such as a brake caliper. The cheek portion may also have at least one nonworking portion that is not acted upon directly by the braking element. The cheek portion may comprise a first material. The working portion may have a first density, and the nonworking portion may have a second density that is different than the first density.

One exemplary embodiment includes a product which may include a brake rotor including a cheek portion. The cheek portion may have a first working surface directly contacting a braking element such as a brake pad during use. The cheek portion may also have a second working surface directly contacting the braking element. The second working surface may be located on an opposite side of the cheek portion with respect to the first working surface. The cheek portion may also have a solid interior portion located between the first and second working surfaces. The first and second working surfaces may each have a density that, though need not necessarily be exactly the same with respect to each other, has a greater value than a density measured at an axial centerline of the interior portion.

One exemplary embodiment includes a method which may include shaping and compacting. The shaping may include shaping a powdered metallurgy material into a preform that may have a surface and an interior portion. The compacting may include compacting the form to make the surface denser than the interior portion.

One exemplary embodiment includes a damped product which may include a powder metallurgy material. The powder metallurgy material may have a first portion and a second portion. The first portion may have a density value that is greater than that of the second portion. The different densities may damp vibrations in the product when the product is vibrated.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a schematic of an exemplary embodiment of a brake rotor being formed by an exemplary powder metallurgical process.

FIG. 2 is an exemplary graph showing relative densities at different locations along the total thickness of a cheek portion of the brake rotor of FIG. 1.

### DETAILED DESCRIPTION OF EXEMPLARY EMBODIMENTS

The following description of the embodiment(s) is merely exemplary in nature and is in no way intended to limit the invention, its application, or uses.

The figures illustrate an exemplary embodiment of a brake rotor 10 that may have a heterogeneous or non-uniform density that may damp or otherwise dissipate vibrations and other sound-generating events in the brake rotor which may result when a pair of brake pads (not shown) is forced against the brake rotor or vibrated component. At least a portion of the brake rotor 10 may be manufactured by a powder metallurgical process which may reduce weight and cost as compared to other manufacturing processes. In some cases, the powder metallurgical process may also permit some control over certain attributes including density. Although the following description is provided in the context of an automotive application and particularly a brake rotor, it should be appreciated that the method described can be used in other applications to produce other products that are subject to vibration during use. For example, other products may include, but are not limited to, a brake drum, an electric motor, a transmission housing, a gear housing, an exhaust manifold, a cylinder head, a bracket, and other products subjected to vibrations.

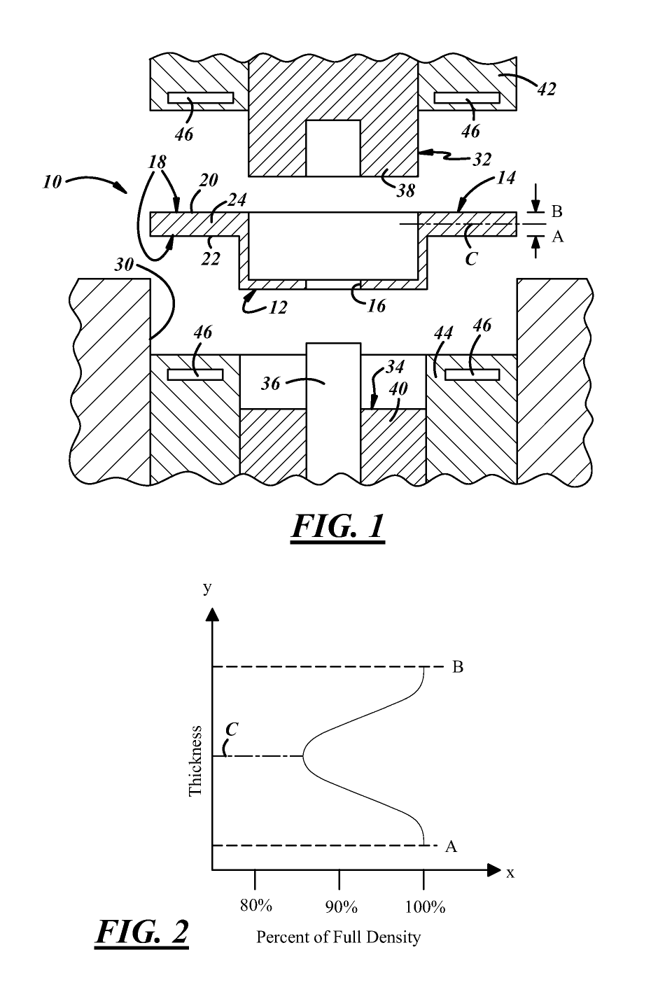

Referring to FIG. 1, the brake rotor 10 may be of the solid-type as shown, may be of the vented-type (not shown) having a plurality of vanes, or may be another type. The brake rotor 10 may include a hub portion 12 and a cheek portion 14 extending from the hub portion. The hub portion 12 may have a central aperture 16 and may have a plurality of bolt holes (not shown) for mounting the brake rotor 10. The cheek portion 14 may have a working portion 18 that is acted upon or worked on by a braking element such as a brake caliper (not shown) and brake pads during a braking event. For example, the working portion 18 may include portions of the cheek portion 14 that may be subject to wear throughout the effective lifetime of the brake rotor 10. The pair of brake pads may make direct contact with exposed portions of the working portion 18 during the braking event which generates friction therebetween and slows the associated automobile.

The working portion 18 may include a first working surface 20, a second working surface 22, and a portion of the cheek portion 14 that extends to a depth slightly below the respective exterior working surfaces and into the interior of the cheek portion. The first working surface 20 may be located on one side of the cheek portion 14, and the second working surface 22 may be located on an opposite side of the cheek portion with respect to the first working surface. The first and second working surfaces 20 and 22 may be directly acted upon and contacted by the brake pads during the braking event. In the illustrated embodiment, the cheek portion 14 may be solid and one-piece between the first and second working surfaces 20 and 22.

The brake rotor 10 may also include a nonworking portion that is not directly acted upon or worked on by the brake caliper during the braking event. The nonworking portion may not be subject to wear throughout the effective lifetime of the brake rotor 10, and may not be acted upon to such a strenuous degree as the working portion 18. The nonworking portion may not make direct contact with the brake pads. The nonworking portion may include portions of the hub portion 12 and an interior portion 24 of the cheek portion 14. For example, the nonworking portion may include portions of the hub portion 12 that are not acted directly upon by the brake caliper or the brake pads. The interior portion 24 may include a portion of the cheek portion 14 that is located axially between the first working surface 20 and the second working surface 22, but may not include portions of the working portion 18. The interior portion 24 may define a centerline C that may be directed along an imaginary radius of the cheek portion 14 and may be located at an axial centerpoint of the cheek portion.

In select embodiments, the brake rotor 10 may be composed of various powdered metallurgy materials including, but not limited to, titanium, steel, aluminum, magnesium, zinc, and alloys thereof. Both the hub portion 12 and the cheek portion 14 may be made of the same material or of a different material.

In one embodiment, the cheek portion 14 may be manufactured separately from the hub portion 12, and the hub portion may be subsequently joined to the cheek portion by a variety of methods including casting, welding, adhesive bonding, mechanically locking, and the like.

In one embodiment, at least a portion of the brake rotor 10 may be manufactured by a powder metallurgical process. As will be appreciated by skilled artisans, the exact powder metallurgical process used to form the brake rotor 10 or a portion thereof, including the number of steps, the order of the steps, the parameters within each step, and the like, may vary and may depend on, among other things, the desired construction, the material used, certain desired attributes as will be subsequently described, and the like. The powder metallurgical process may be of the powder forging type, the press-and-sinter type, or another type. The powder metallurgical process may produce a brake rotor of lower weight as compared to brake rotors produced by other processes, and may facilitate mass production.

In an example powder metallurgical process, a powdered metallurgy material may be shaped, may be compacted, and may be heated. Referring still to FIG. 1, in the shape step, a charge of powdered metallurgy material such as titanium may be put into a mold cavity 30. The charge may be injected into the mold cavity 30, may be simply dropped into the mold cavity, or may be fed some other way. The charge may be initially shaped into a preform, or green part, by an initial compaction. An upper punch 32 and a lower punch 34 may be brought together, and one or more core rods 36 may remain stationary in order to form the central aperture 16 and the plurality of bolt holes in the brake rotor 10 if the hub portion is to be made by the powder metallurgy process. This step may be performed at room temperature or at an elevated temperature. In the compact step, pressure may be applied to the charge, or to the preform by the upper and lower punches 32 and 34 as the punches are brought together. The upper and lower punches 32 and 34 press against the charge or preform to produce a somewhat final form. In the heat step, the final form may be subjected to relatively high temperatures in order to convert existing mechanical bonds between the powdered titanium into metallurgical bonds or sinter the powder. In some cases, the heat step need not necessarily be performed. The high temperatures may come from a sintering step that may be performed in a separate controlled atmosphere furnace, may be performed simultaneously with the compaction step and at the upper and lower punches 32 and 34, or in some other way. In some examples, the initial compaction and heating steps may not be needed; for example, the compaction step may be performed at room temperature.

Depending upon the exact steps and parameters, certain attributes may be somewhat affected by, and somewhat controlled in the powder metallurgical process. For example, density and a related porosity may be affected and controlled. Different amounts of compaction pressure may be applied at different portions of the brake rotor 10 to produce different densities and porosities at the respective portions. In one example, a first upper punch 38 and a first lower punch 40 may apply a first pressure to form the hub portion 12, and a second upper punch 42 and a second lower punch 44 may apply a second pressure to form the cheek portion 14. The first pressure may have a lower value than the second pressure, which may result in the cheek portion 14 being denser, or having a higher density, than the hub portion 12. Of course, other compaction parameters and steps may be possible.

In another example, different degrees of temperature and durations of temperature exposure may be applied at different portions of the brake rotor 10 to produce different densities and porosities at the respective portions. In one example, a plurality of heating elements 46, such as induction heaters, may be located in the upper punch 32 and in the lower punch 34. The heating elements 46 may direct heat at the cheek portion 14 and not directly at the hub portion 12, such that the hub portion 12 is heated to a first temperature and the cheek portion 14 is heated to a second temperature. The second temperature may have a greater value than the first temperature, which may result in the cheek portion 14 being denser than the hub portion 12. Similarly, the heating elements 46 may direct heat at the working portion 18 and not directly at the nonworking portion to produce a like result.

In another example, the heating elements 46 may apply a relatively intense and of relatively short duration heat to the working portion 18 and not necessarily to the nonworking portion, which may result in the working portion being heated to a third temperature and the nonworking portion being heated to a fourth temperature. The third temperature may have a greater value than the fourth temperature, which may result in the working portion 18 having a first density that is greater in value than a second density of the nonworking portion. The heating elements 46 may do the same to the cheek portion 14 and the hub portion 12 to give the cheek portion a greater density than the hub portion. In yet another example, the heating elements 46 may apply a heat to the cheek portion 14 for a longer duration as compared to a duration for the hub portion 12. This again may result in the cheek portion 14 being denser than the hub portion 12, and again the heating elements 46 may respectively do the same to the working portion 18 and the nonworking portion to produce a similar result. Of course, other heating parameters and steps may be possible.

In another embodiment, the cheek portion 14 may be made by a wet or dry powder compaction process to produce a green part that is subsequently fired or sintered in a furnace. This may result in the working portion 18 being denser than the nonworking portion.

In yet another embodiment, a multi-density brake rotor as described above may be made using powder sintering stereolithography using powder of various sizes to produce various densities in the cheek portion 14.

The above-described steps and parameters may result in different densities and porosities at different portions of the brake rotor 10. In some cases, the different densities and porosities may help damp or otherwise dissipate vibrations, oscillations, and other sound-generating events in the brake rotor 10. It is currently believed that the different densities and porosities damp vibrations, oscillations, and other sound-generating events due to relative movement between individual particles in the brake rotor 10; of course other causes may exist. Furthermore, the different densities and porosities may produce anharmonic behavior in the brake rotor 10, which may consequently damp vibrations, oscillations, and other sound-generating events. Referring to the exemplary graph of FIG. 2, the relative densities of the cheek portion 14 may vary along a thickness between the first working surface 20 (phantom line B) and the second working surface 22 (phantom line A), the graph showing an exemplary density gradient or varying density gradually therebetween. Relative density may refer to the ratio of the density at a particular location along the thickness of the cheek portion 14 to that of a pore-free or fully dense cheek portion. The graph shows a decreasing density from the first and second working surfaces 20 and 22, and toward the centerline C of the interior portion 24 according to one exemplary embodiment. In one example, the first and second working surfaces 20 and 22 may have a relative density between about 95% and 100% of the full density; and the centerline C and the interior portion 24 may have a relative density between about 85% and 98% of the full density. Having a density of higher value at the working portion 18 as compared to the nonworking portion may help ensure robustness and stability at the working portion during the braking event without sacrificing the same in the brake rotor 10.

In some cases, a higher relative density may translate to a lower porosity. As such, the working portion 18 may have a lower porosity than the nonworking portion, which may help damp or otherwise dissipate vibrations and other oscillations in the brake rotor 10.

In some embodiments, secondary operations may be performed to the brake rotor 10 after the powder metallurgical process is performed. For example, a friction-stir process can be applied to the first working surface 20, to the second working surface 22, or to both the first and second working surfaces. Skilled artisans will know that in one example friction-stir process, or resistance welding, frictional heat is generated between a rotating tool and the particular working surface. At that increased temperature, the working surface is brought to full or near-full density as discussed above. Furthermore, in some embodiments, an insert may be located within the brake rotor 10. The insert may be a separate piece than the brake rotor 10 and may be made of a different material than the brake rotor. The insert may be partially or totally surrounded by the brake rotor 10. The insert may be placed within the brake rotor 10 as part of the powder metallurgical process; for example, by compacting the powdered metal around the insert, in which the insert may be initially held in place by retractable locating pins extending from the lower punch 34 and into mold cavity 30, or by other means. The combination of the different densities and the insert may further help damp or otherwise dissipate vibrations and other oscillations in the brake rotor 10.

The above description of embodiments of the invention is merely exemplary in nature and, thus, variations thereof are not to be regarded as a departure from the spirit and scope of the invention.

What is claimed is:

1. A product comprising:
a brake rotor comprising a cheek portion comprising a working portion acted upon by a braking element during use and being made of a first material, and the cheek portion comprising a nonworking portion not acted upon by the braking element during use and being made of the first material, the working portion having a first density and the nonworking portion having a second density that is different than the first density.

2. A product as set forth in claim 1 wherein the working portion comprises a working surface of the cheek portion contacting the braking element during use.

3. A product as set forth in claim 1 wherein the working portion comprises a first working surface of the cheek portion contacting the braking element during use, and comprises a second working surface of the cheek portion contacting the braking element during use and located on an opposite side of the cheek portion than the first working surface, and the cheek portion being solid between the first and second working surfaces.

4. A product as set forth in claim 1 wherein the nonworking portion comprises at least some of an interior portion of the cheek portion.

5. A product as set forth in claim 1 wherein the first density has a greater value than the second density.

6. A product as set forth in claim 5 wherein the first density is between about 95% and 100% full density, and the second density is between about 85% and 98% full density.

7. A product as set forth in claim 1 wherein the first material comprises titanium.

8. A product as set forth in claim 1 wherein the first material comprises at least one of steel, aluminum, magnesium, zinc, and alloys or oxides thereof.

9. A product as set forth in claim 1 wherein the first material comprises a sintered powder metallurgy material.

10. A product comprising:
a brake rotor comprising a cheek portion comprising a first working surface contacting a braking element during use and comprising a second working surface contacting the braking element during use and located on an opposite side of the cheek portion than the first working surface, and the cheek portion further comprising a solid interior portion located between the first and second working surfaces, wherein the first and second working surfaces each have a density that is greater in value than a density of an axial centerline of the interior portion.

11. A product as set forth in claim 10 wherein the brake rotor comprises titanium and is made by a powder metallurgy process that gives the density of greater value to the first and second working surfaces.

12. A product as set forth in claim 10 wherein the density of the first and second working surfaces is between about 95% and 100% full density, and the density of the axial centerline is between about 85% and 98% full density.

13. A product as set forth in claim 10 wherein the density gradually decreases in value from one of the first or second working surfaces and toward the axial centerline.

14. A method of making a damped product comprising:
shaping a powdered metallurgy material into a preform having a surface and an interior portion; and
compacting the preform to make the surface denser than at least some of the interior portion.

15. A method as set forth in claim 14 wherein the compacting further comprises compacting the surface to a first density and compacting the interior portion to a second density having a lesser value than the first density.

16. A method as set forth in claim 15 wherein the compacting further comprises compacting the surface at a first pressure and compacting the interior portion at a second pressure having a lesser value than the first pressure.

17. A method as set forth in claim 14 wherein the powdered metallurgy material comprises titanium.

18. A method as set forth in claim 14 further comprising:
sintering the compacted form to provide the damped product.

19. A method as set forth in claim 18 wherein the sintering further comprises sintering the surface at a first temperature and sintering the interior portion at a second temperature that is less than the first temperature.

20. A damped product comprising:
a powder metallurgy material having a first portion and a second portion, the first portion having a density greater than the second portion so that vibrations in the product are damped by the different densities of the first and second portions.
